(19) United States
(12) Patent Application Publication
(10) Pub. No.: US 2007/0223505 A1
(43) Pub. Date: Sep. 27, 2007

(54) DATA TRANSMISSION APPARATUS, DATA TRANSMISSION METHOD AND DATA TRANSMISSION SYSTEM

(76) Inventors: Kimio ITAI, Tokyo (JP); Yoshikuni Ito, Tokyo (JP); Hirotake Wakai, Tokyo (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/677,694

(22) Filed: Feb. 22, 2007

(30) Foreign Application Priority Data
Mar. 22, 2006 (JP) 2006-078155

(51) Int. Cl. H04L 12/56; H04L 12/54

(52) U.S. Cl. 370/412; 370/428

(57) ABSTRACT

A data transmission apparatus is disclosed, which includes a first terminal for use with variable-rate data, a second terminal for use with constant-rate data, a processing unit for input of data from the first and second terminals, a modulator unit for modulating the output of the processor unit, a control unit for controlling the modulator, and a transmitter unit. The processor has a first buffer for writing thereinto data from the first terminal, a second buffer for writing therein data from the second terminal, and a selector for reading data from either one of the first and second buffers while switching therebetween at a predetermined rate, thereby allowing the switching of the selector to be performed under the control of the control unit.

### CROSS-REFERENCE TO RELATED APPLICATION

This application claims priority from Japanese Patent Application (JPA) No. 2006-078155, filed on Mar. 22, 2006, the contents of which are incorporated herein by reference.

### BACKGROUND OF THE INVENTION

The present invention relates generally to data transmission apparatuses and data transmission systems, and more particularly to a data transmission apparatus for sending data that are different in transmission rate from each other via a digital radio-communication link(s) between two land points and also to a data transmission system using the apparatus.

In recent years, an over-the-air subscriber access system, called the fixed wireless access (FWA) system, has been in practical use. As shown in FIG. 8, this system is typically arranged to include an “A” radio device 801 and a “B” radio device 802, which are communicable over the air with each other through their antennas 803 and 804. These radio devices 801 and 802 are connected respectively to transmission channels 805 and 806, such as public telephone networks or the Internet, for enabling establishment of linkage for communication between subscriber terminal devices (not shown) which are presently connected to the transmission channels 805-806 respectively or, alternatively, connection to a subscriber network, such as a local area network (LAN).

The data transmission system with such arrangement is adaptable for use in providing services for radio-communications between subscribers who are at two spaced land points—for example, one of them is an isolated island whereas the other is a mountain village area. This type of data transmission over radiocommunication channels is widely employed because of its advantage as to an ability to provide communication services for subscribers without having to lay high-cost undersea or “submarine” cables and extra-long transmission lines. Additionally, the A radio device 801 and B radio device 802 have transmit/receive (Tx/Rx) functionalities, respectively.

Consequently, the data transmission system such as shown in FIG. 8 is merely such that data transmission is carried out at a predetermined rate or by use of adaptive modulation techniques. Here, a brief explanation will be given of a data transmission system of the type using the adaptive modulation. The adaptive modulation-used data transmission system can sometimes experience occurrence of transmission quality reduction in a way depending upon conditions of in-use radiocommunication links—for example, rainfall-raised electric wave attenuation, phasing or multipath. An approach to avoiding this is to use a specific adaptive modulation technique for changing the data transmission scheme or for switching between modulation scheme candidates in conformity to the communication quality. This adaptive modulation technique is suitably adaptable for use in some network environments for transmission of a certain signal where data occurs in a burst way, such as for example Ethernet®, because of the fact that changing the transmission scheme results in a change in transmission rate depending on a present state of geographical interval of radiocommunications. Unfortunately, use of this adaptive modulation technique is less effective for the transmission of transmission rate-fixed data signals such as serial signals, transmission of constant transmission rate data signals, e.g., G.703 signals (the standards defining the interface of digital high-speed communications)—this is generally known as serial signal transmission—or data transmission at a constant rate of, for example, 64 kilobits per second (Kbps), 1.544 megabits per second (Mbps) or 6.312 Mbps.

Also note that in the case of communications that are established by a modulation scheme at its maximum transmission rate, this maximum transmission rate is more than the transmission rate of a serial signal for communication so that irreverent data (e.g., data of zeros, called the null data) are to be received and transmitted, resulting in waste of transmission frequency band(s). In addition, since the adaptive modulation technique accompanies a change in capacity of data transmission, the execution of serial signal transmission is with limited guarantee of only a band corresponding to the minimum transmission rate of adaptive modulation. Thus, in an event that the serial signal transmission rate is greater than the minimum transmission rate of the adaptive modulation, the transmission band of serial signal transmission is no longer guaranteeable. Also note that in radiocommunications links using the adaptive modulation, any hybrid data transmission architecture for transmitting in combination a burst signal as in Ethernet signal transmission and a serial signal has not yet been reduced to practice. Thus, it is desired to achieve a data transmission apparatus capable of transmitting over-the-air the data of different transmission rates over a radiocommunications channel and a data transmission system using the apparatus.

### SUMMARY OF THE INVENTION

It is thus desired to achieve a data transmission apparatus capable of transmitting over-the-air data of different transmission rates via a radiocommunications link(s) employing adaptive modulation while guaranteeing the band of serial signal transmission and a data transmission system using the apparatus.

It is therefore an object of the present invention to provide a data transmission apparatus capable of sending data of different transmission rates via a radiocommunication channel and a data transmission system using the apparatus.

It is another object of this invention to provide a data transmission apparatus capable of guaranteeing the band for serial signal transmission in the data transmission of an adaptive modulation scheme and a data transmission system using the same.

It is a further object of the invention to provide a data transmission apparatus which guarantees the band of serial signal transmission in data transmission of adaptive modulation scheme and which allocates to the remaining band a signal where data occurs burst, and also to provide a data transmission system using this apparatus.

A data transmission apparatus incorporating the principles of this invention is arranged to include at least one first input/output terminal for input of a data signal being variable in transmission rate, at least one second input/output terminal for input of a data signal being kept constant in transmission rate, an input/output signal processing unit for input of the data signals from the first input/output terminal and the second input/output terminal, a modulator unit operative to modulate an output of the input/output signal processing unit, a first control unit for control of the modulator unit, and a transmitter unit for sending an output of the modulator unit via a radiocommunication channel. The input/output signal processing unit includes a first transmission buffer memory for writing thereinto the data signal from the first input/output terminal, a second transmission buffer memory for writing therein the data signal from the second input/output terminal, and a first selector for reading out of the first transmission buffer memory and the second transmission buffer memory while switching therebetween at a prespecified read speed. The switching of the first selector is controlled by the first control unit.

In the data transmission apparatus of this invention, the first selector operates under control of the control unit to perform a switching operation in such a way as to allocate to the data signal as read from the second transmission buffer memory a transmission capacity corresponding to the data signal of constant transmission rate and being included in a transmission capacity of the data signal to be modulated at the modulator unit while allocating the remaining transmission capacity of the data signal to be modulated at the modulator unit to transmission of the data signal as read out of the first transmission buffer memory.

Additionally in the data transmission apparatus of this invention, the modulator unit is the one that permits the modulation scheme to be switched in a way pursuant to a present state of the transmission of the radio link and is arranged also to have switchability of the operation of the selector in responding to the change of the modulation scheme.

In the data transmission apparatus of this invention, the information that indicates the data as read from the first transmission buffer memory and the second transmission buffer memory is added to the data signals which is read from the first transmission buffer memory and the second transmission buffer memory respectively.

In the data transmission apparatus of this invention, it further includes a receiver unit for receipt of a data signal to be sent over a radiocommunication channel, a demodulator unit for demodulation of an output of the receiver unit, and a second control unit for control of the demodulator unit. An output signal of the demodulator unit is supplied to the input/output signal processing unit. The input/output signal processing unit further includes a second selector, a first reception buffer memory for writing thereinto an output of the second selector and a second reception buffer memory. The second selector is operable based on control of the second control unit to switch the output of the demodulator unit for writing into the first reception buffer memory and the second reception buffer memory respectively and to output data signals being written into the first reception buffer memory and the second reception buffer memory to the first input/output terminal and the second input/output terminal, respectively.

This invention also provides a data transmission system having a first radio device and a second radio device which communicate each other via a radiocommunication channels. The first radio device includes at least one first input/output terminal for input of a data signal being variable in transmission rate, at least one second input/output terminal for input of a data signal being kept constant in transmission rate, an input/output signal processor unit for input of data signals from the first input/output terminal and the second input/output terminal, a modulator unit operative to modulate an output of the input/output signal processor unit, a first control unit for control of the modulator unit, and a transmitter unit for sending an output of the modulator unit over the radiocommunication channel. The input/output signal processor unit includes a first transmission buffer memory for writing thereinto the data signal from the first input/output terminal, a second transmission buffer memory for writing therein the data signal from the second input/output terminal, and a first selector for reading data out of the first transmission buffer memory and the second transmission buffer memory while switching therebetween at a prespecified read speed. The switching of the first selector is controlled by the first control unit. The second radio device is arranged to receive the data signal from the transmitter unit.

In addition, in the data transmission system of the invention, the first radio device further includes a receiver unit for receipt of a data signal as sent from the second radio device, a demodulator unit for demodulating an output of the receiver unit, a second control unit for control of the demodulator unit, and a second control unit which controls the demodulator unit. An output of the demodulator is supplied to the input/output signal processor unit. This signal processor further includes a second selector, a first reception buffer memory for writing thereinto an output of the second selector, and a second receipt buffer memory. The second selector is arranged to switch the output of the demodulator unit under control of the second control unit to thereby write it into the first receipt buffer memory and the second receipt buffer memory, respectively, and then output the data signals as written into the first receipt buffer memory and the second receipt buffer memory to the first and second input/output terminals, respectively.

As apparent from the foregoing, according to this invention, it is possible to achieve the intended data transmission apparatus and system capable of sending over-the-air data signals that are different in transmission rate from each other. Another advantage lies in realization of efficient data transmission by combining or “hybridizing” together a transmission rate-variable transmission channel and a transmission rate-fixed channel while at the same time offering increased applicability upon installation into a system and also making easier the selection of a channel in the establishment of a radiocommunications system. Further, it is possible to actualize a data transmission apparatus capable of well guaranteeing the band of serial signal transmission and a data transmission system using the apparatus.

These and other objects, features and advantages of the invention will be apparent from the following more particular description of currently embodiments of the invention, as illustrated in the accompanying drawings.

### BRIEF DESCRIPTION OF THE DRAWINGS

FIG. 1 is a block diagram schematically showing an overall configuration of one embodiment of the present invention.

FIG. 2 is a diagram for explanation of an operation of one embodiment of this invention.

FIG. 3 is a diagram for explanation of a signal format of one embodiment of the invention.

FIG. 4A is a diagram for pictorially illustrating combined or hybrid data of one embodiment of the invention.

FIG. 4B is a diagram for pictorial representation of creation of hybrid data of one embodiment of the invention.

FIG. 5 is a block diagram showing an overall configuration of one embodiment of the invention.

FIG. 6 is a diagram for explanation of a signal format of another embodiment of this invention.

FIG. 7 is a diagram for explanation of one embodiment of a data transmission system of this invention.

FIG. 8 is a diagram for explanation of an exemplary prior art data transmission system.

FIG. 9 is a diagram for pictorial representation of recovery of hybrid data of one embodiment of the invention.

### DESCRIPTION OF THE EMBODIMENTS

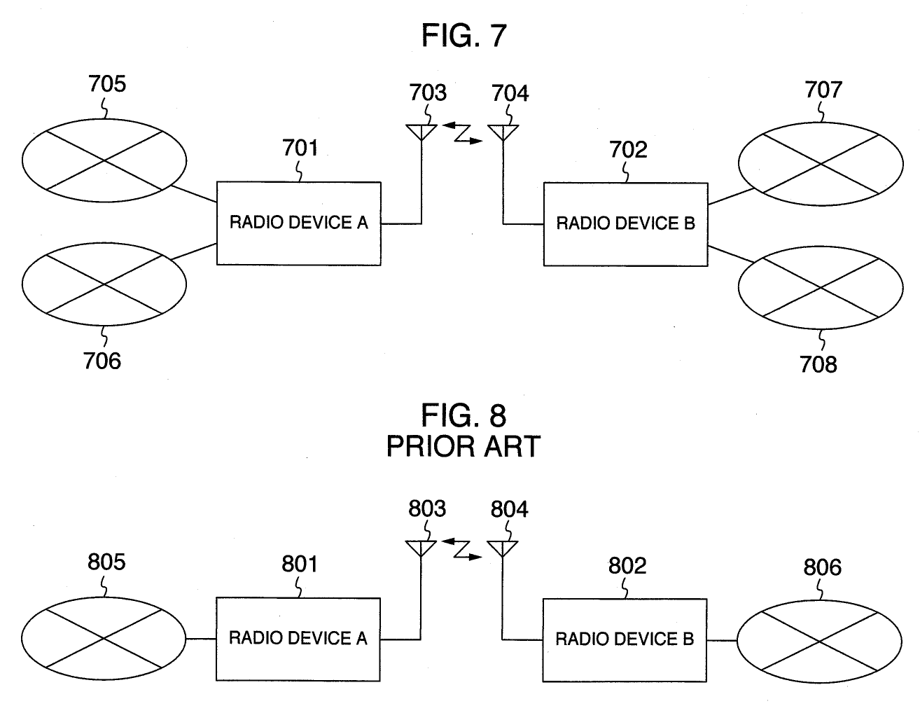

One embodiment of the present invention will be described with reference to some of the accompanying drawings below. FIG. 7 illustrates, in schematic block diagram form, an overall configuration of the embodiment of this invention. In FIG. 7, an “A” radio device 701 and a “B” radio device 702 are arranged to communicate over-the-air with each other via antennas 703 and 704 thereof. The A radio device 701 is connected, for example, to transmission lines 705 and 706, such as a public telephone line network and the Internet, respectively. In the illustrative embodiment, the transmission line 705 is a transmission channel for transmitting a specific signal with data being generated in a burst way such as in Ethernet—this will be referred to hereinafter as the burst Internet Protocol (IP) packet signal or otherwise “variable transmission rate signal.” The transmission line 706 is a transmission channel for transmission of a signal which is kept constant in data transmission rate such as for example in G.703 standards, which is generally called the serial transmission among those skilled in the art and will be referred to as “constant transmission rate signal.”

Similarly, the B radio device 702 is connected for example to transmission lines 707 and 708, such as a public phone line and the Internet, respectively. In this embodiment, the transmission line 707 is a transmission channel which sends forth a signal where data occurs burst as in the Ethernet (i.e., variable transmission rate variable signal) whereas the transmission line 708 is a transmission channel for transmission of a signal with constant data transmission rate as in G.703 for example (constant transmission rate signal).

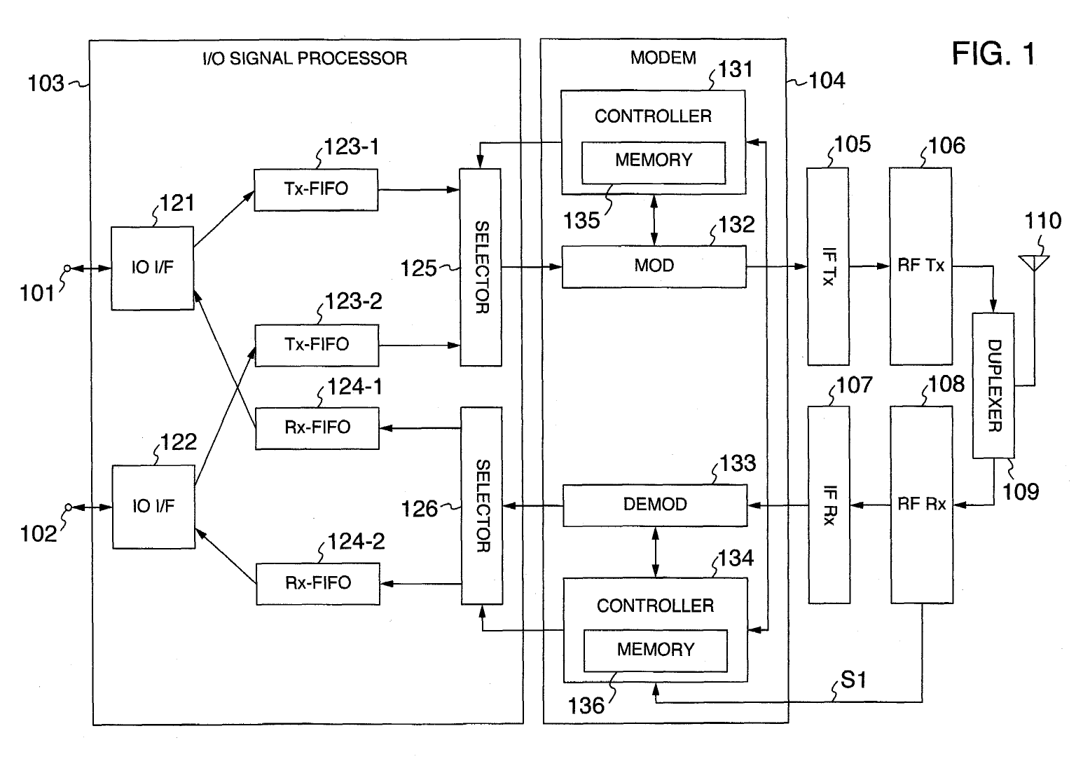

An explanation will next be given of the A radio device 701 and B radio device 702 while referring to FIG. 1. Note here that these radio devices 701-702 are similar in arrangement to each other, so the explanation herein is drawn to the A radio device 701 only. The same goes with the B radio device 702 so that its explanation is eliminated. In FIG. 1, reference numeral 101 designates an input/output terminal (referred to as first input/output terminal hereinafter) with a variable transmission rate signal being supplied thereto, which terminal is connected to the transmission channel 705 of FIG. 7, for example. Numeral 102 denotes an input/output terminal (second input/output terminal), to which a constant transmission rate signal is supplied and which is connected, for example, to the transmission channel 706 of FIG. 7. 103 is an input/output signal processing unit 103, and 104 is a modulator/demodulator (modem) unit 104. 105 is an intermediate frequency (IF) transmitter unit (IF Tx), which converts an output signal of the modem unit 104 into a signal with an intermediate frequency of 130 MHz, for example, and then supplies it to a radio-frequency (RF) transmitter unit 106. This RF transmitter unit (RF Tx) 106 amplifies the supplied signal and converts it into a radio carrier with a frequency band of 18 GHz, as an example, and then sends it from the antenna 110 via a duplexer 109 to the B radio device 702.

On the other hand, an incoming signal from the B radio device 702 is supplied to an RF signal receiver unit (RF Rx) 108 by way of the antenna 110 and the duplexer 109. The RF receiver unit 108 amplifies the received signal from the antenna 110 for conversion to an IF signal with a frequency of 290 MHz for example and then supplies it to an IF receiver unit (IF Rx) 107. This IF receiver unit 107 converts the supplied signal into a baseband signal and supplies it to the modem unit 104.

The input/output signal processor unit 103 is generally made up of input/output interfaces (IO I/Fs) 121 and 122, a signal transmission buffer memory (Tx-FIFO) 123-1 for use with the variable transmission rate signal such as a first-in/first-out (FIFO) memory, which will be referred to hereinafter as first transmission (Tx) buffer memory, a transmission FIFO buffer memory 123-2 for use with the constant transmission rate signal to be referred to as second Tx buffer memory, a signal reception FIFO buffer memory (Rx-FIFO) 124-1 for use with the variable transmission rate signal as will be referred to as first reception (Rx) buffer memory, a reception FIFO buffer memory 124-2 for use with the constant transmission rate signal to be referred to as second Rx buffer memory, a selector (first selector) 125, and a selector (second selector) 126. The modem unit 104 includes control units 131, 134, a modulator (MOD) 132, and a demodulator (DEMOD) 133. Each control unit 131, 134 has its memory unit 135, 136.

An operation of the data transmission apparatus shown in FIG. 1 will next be described below. First, an explanation will be given of an adaptive modulation technique of the modem unit 104. As previously stated, a data transmission system using adaptive modulation can experience unwanted occurrence of a decrease in quality of transmitted signals due to some affectors—e.g., rainfall-caused attenuation of electromagnetic waves, phasing or the presence of a multipath—in a radiocommunication link (radio transmission part) between the A radio device 701 and B radio device 702, for example, as shown in FIG. 7. Thus a need is felt to use a technique for switching between transmission schemes or modulation schemes in conformity with the transmission signal quality (communication quality) thereof. This will be discussed below.

Transmission data from the input/output signal processor unit 103 is modulated by a predetermined kind of modulation scheme and then supplied to the IF transmitter unit 105. Typical examples of the modulation scheme in this modulator unit 132 are binary phase shift keying (BPSK), quadrature phase shift keying (QPSK), 16-quadrature amplitude modulation (16QAM), and 64QAM. The control unit 131 is arranged to control the modulator unit 132 in accordance with the sensitivity of a signal as received on the receiver side to thereby switch between the modulation schemes such as BPSK, QPSK, 16QAM and 64QAM in an automated way. Practically, for example, a received-signal electrical field intensity table is prestored in the memory unit 135, which is given below in Table 1.

TABLE 1

| Modulation | | | | |
|---|---|---|---|---|
| Scheme | BPSK | QPSK | 16QAM | 64QAM |
| Minimum Rx | −80 | −70 | −60 | −50 |
| Field | | | | |
| Intensity | | | | |
| (dBm) | | | | |

Table 1 above is a table indicating the minimum received-signal electric field intensity relative to respective modulation schemes. For instance, upon receipt of an inbound signal from the B radio device 702 at the antenna 110, this signal is supplied via the duplexer 109 to RF signal receiver unit 108. At this time, the RF receiver 108 measures a received electric field intensity signal S1, which will be input to the control unit 134 and also to the control unit 131. For example, in the case of signal transmission being performed by the modulation scheme of 16QAM shown in Table 1, this received field intensity can sometimes drop down to reach a prespecified level—e.g., −60 dBm or less—due to influences on transmission channels, such as rainfall, phasing, multipath or else. If this is the case, the received signal can no longer be properly demodulated. To avoid this, it is needed to change the presently selected modulation scheme to another to thereby ensure that the signal received is properly demodulated.

Accordingly, the control unit 131 refers to the received field intensity table shown in Table 1 as stored in the memory unit 135 to select one from among the modulation schemes BPSK, QPSK, 16QAM and 64QAM shown in Table 1—for example, QPSK modulation scheme—and then change thereto the presently used modulation scheme. In Table 1 the minimum received field intensity of QPSK modulation is −70 dBm, so any received signal with its field intensity of −60 dBm is receivable successfully, resulting in correct reproduction of such signal. When the received field intensity further decreases, the control unit 131 changes it to another, e.g., BPSK modulation scheme. In this way, the control unit 131 automatically switches to the best-suited modulation scheme whenever a presently received signal's field intensity becomes lower than a prespecified level due to the influences on transmission paths such as rainfall, phasing, multipath or else, thereby to make sure that data transmission is done by the optimum modulation scheme in any events. It should be noted that although in this embodiment the adaptive modulation technique is employed for changing or switching between the modulation schemes based on the received signal field intensity, this approach is not to be construed as limiting the invention, and the received signal's bit error rate (BER) or equalized error signal may alternatively be used. Regarding the demodulator unit 133, information as to the modulation scheme at the modulator unit 132 is sent to the control unit 134 from the control unit 131. Thus, a demodulating operation is performed for its corresponding modulated signal, resulting in the demodulated signal being supplied to the input/output signal processor unit 103.

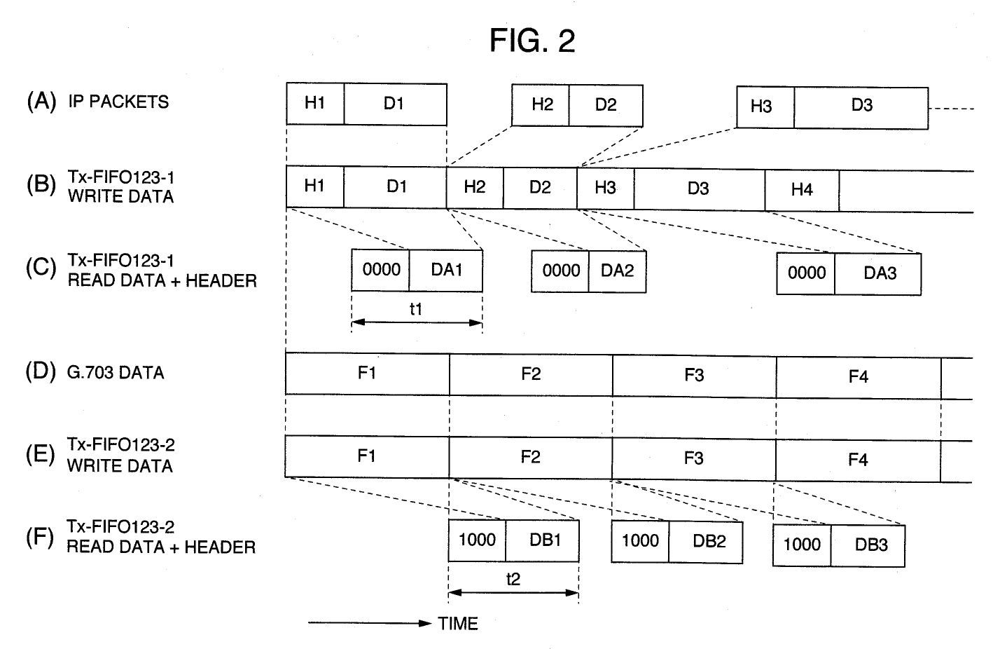

An operation of the input/output signal processor unit 103 will next be described. Firstly, a variable transmission rate signal is supplied to the input/output terminal 101 whereas a constant transmission rate signal is fed to the input/output terminal 102. The variable-rate signal supplied to the input/output terminal 101 is sequentially written through the IO I/F 121 into the first Tx-FIFO buffer memory 123-1 at a predetermined writing speed. The signal thus written into this buffer memory will be sequentially read out of it at a prespecified read speed and then supplied to the selector 125. Meanwhile, the constant-rate signal as supplied to the input/output terminal 102 is sequentially written via the IO I/F 122 into the second Tx-FIFO buffer memory 123-2 at a specified write rate. The signal thus written into this buffer memory will be sequentially read therefrom at a specified read rate and then supplied to the selector 125. These variable rate signal-use Tx-FIFO buffer memory 123-1 and constant rate signal-use Tx-FIFO buffer memory 123-2 operate in a way as will be explained with reference to FIG. 2 below.

FIG. 2 shows at part (A) an exemplary Internet Protocol (IP) packet signal with data occurring in a burst way, which signal is supplied to the input/output terminal 101. This IP packet signal has data segments D1, D2, D3, . . . , each having a header H1, H2, H3, . . . with a packet number or else being added thereto. In part (B) of FIG. 2, data to be written into the Tx-FIFO buffer memory 123-1 are shown. More specifically, as shown in (B) of FIG. 2, those portions of a burst-like IP packet data signal to be supplied from the IO I/F 121 are sequentially written into the variable transmission rate signal-use Tx-FIFO buffer memory 123-1 at a specified write rate. Note here that this specified write rate may alternatively be set to 10 Mbps, which is a write speed of data being written into the variable transmission rate signal-use Tx-FIFO buffer memory 123-1 in the case of the transmission channel being connected to the input/output terminal 101, e.g., LAN transmission channel, is 10 Mbps in its transmission rate.

Similarly, part (D) of FIG. 2 shows data of an exemplary constant transmission rate signal to be supplied to the input terminal 102, e.g., G.703 signal, which has transmission frames F1, F2, . . . . In part (E) of FIG. 2, data to be written into the Tx-FIFO buffer memory 123-2 are shown. More specifically, as shown in (E) of FIG. 2, the data of a constant transmission rate signal, e.g., G.703 data, to be supplied from the IO I/F 122 are sequentially written into the constant transmission rate signal-use Tx-FIFO buffer memory 123-2 at a predetermined write rate. Note here that this write rate may alternatively be set to 6.3 Mbps, which is the speed at which data is written into the constant rate signal-use Tx-FIFO buffer memory 123-2 in case the transmission rate of G.703 data being transmitted over the transmission channel to be connected to the input/output terminal 102 is 6.3 Mbps.

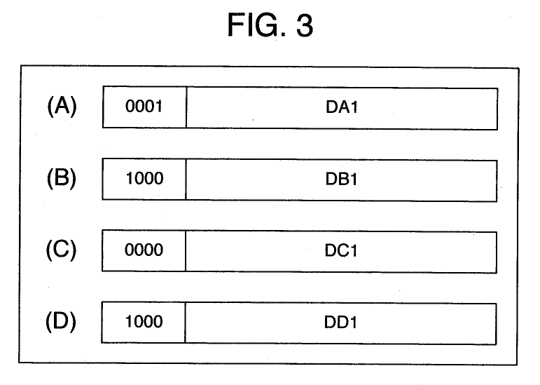

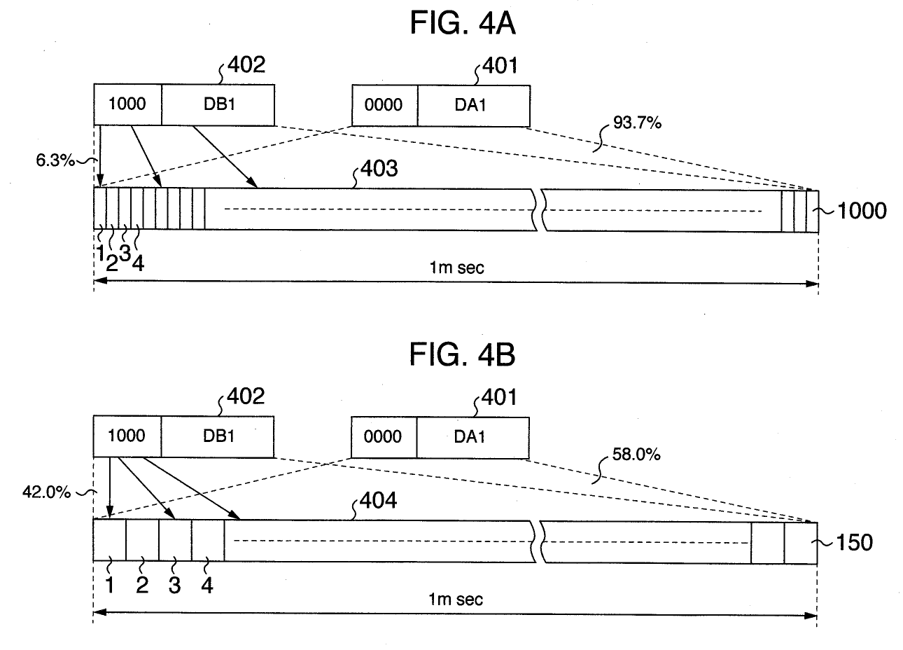

Next, the data as written into the variable transmission rate signal-use Tx-FIFO buffer memory 123-1 and the data written into the constant transmission rate signal-use Tx-FIFO buffer memory 123-2 are selectively read by the selector 125 whenever the need arises and are added header information to be later described and then supplied to the modulator unit 132 in the modem unit 104. This will be explained using FIGS. 3 and 4A-4B. First, the operation of the selector 125 is controlled by the control unit 131 that controls the modulator unit 132. Upon readout of the data as written into the variable transmission rate signal-use Tx-FIFO buffer memory 123-1, the data as read out of Tx-FIFO memory 123-1 is added four-bit header information indicating that it is the data of Tx-FIFO 123-1, which header is processed so that its certain part, e.g., the top bit of four bits is set to “0” as shown in part (A) of FIG. 3. A resultant data string with the header information added to the read data in this case is shown in part (C) of FIG. 2. Here, IP packets are read out of the Tx-FIFO buffer memory 123-1 into the selector 125 on per-IP packet basis; in addition, the headers information H1, H2, H3, . . . also are simultaneously read out while being added to the data D1, D2, D3, . . . , respectively. As IP packet data length information is also added to the header information of IP packets, burst-like IP packets are also selectable by the selector 125 and readable in units of packets. It is noted that a read time period t1 is variable depending upon the transmission rate of radiocommunication link as will be described later. Also note that in case the read rate is lower than the write rate, i.e., when the data transmission rate of radiocommunication channel is less than the transmission rate of data to be supplied to the input/output terminal 101, the data being written into Tx-FIFO buffer memory 123-1 will be overwritten. The burst IP packet signal is allowed to involve signal drop-out. Accordingly, it is arranged so that when such dropped data is required, this dropped signal is again transmitted in response to receipt of a resend request.

In contrast, upon readout of the data being written into the constant transmission rate signal-use Tx-FIFO buffer memory 123-2, the data as read from the Tx-FIFO memory 123-2 is added 4-bit header information indicating that it is the data of Tx-FIFO 123-2, which header is processed so that certain part thereof, e.g., the first bit of its four bits is set to “1” as shown in part (B) of FIG. 3. The resulting data string with the header information being added to the read data in this case is shown in part (F) of FIG. 2. Additionally, assuming that the transmission rate of G.703 data as sent over the transmission channel that is connected to the input/output terminal 102 is 6.3 Mbps, a read time period t2 may typically be the interval in which data is read from the constant transmission rate signal-use Tx-FIFO buffer memory 123-2 at the rate of 6.3 Mbps or faster rates. This is because of the fact that it is required to guarantee the transmission rate since the constant transmission rate signal is no longer reproducible once signal dropout takes place. Additionally in the above-noted embodiment, the read time periods t1 and t2 may be the same in length as each other although these may be made different from each other.

A detailed explanation will be given of the operation of the selector 125. As previously stated, the selector 125 selectively reads, whenever the need arises, the data from the variable transmission rate signal-use Tx-FIFO buffer memory 123-1 and data from constant transmission rate signal-use Tx-FIFO buffer memory 123-2 and then creates a combined or hybrid data. This will be explained with reference to Table 2 and FIGS. 4A-4B.

TABLE 2

| | Transmission | Fixed-Rate | |
|---|---|---|---|
| Modulation | Capacity | Signal | Variable- |
| Scheme | (Mbps) | (6.3 Mbps) | Rate Signal |
| 64QAM | 100 | 6.3% | 93.7% |
| 16QAM | 60 | 10.5% | 89.5% |
| QPSK | 30 | 21.0% | 79.0% |
| BPSK | 15 | 42.0% | 58.0% |

Table 2 above indicates the modulation schemes and transmission capacities thereof. In this embodiment, in the 64QAM modulation scheme, for example, the transmission capacity is defined to be 100 Mbps. It is apparent from Table 2 that in case the transmission rate of the constant transmission rate signal, e.g., G.703 signal, is set at 6.3 Mbps in its transmission rate, the transmission capacity of 100 Mbps is allocated in a way which follows: 6.3% of it is to the transmission of data at 6.3 Mbps of G.703 signal whereas the remaining 93.7% of the 100 Mbps transmission capacity is allocated to a variable transmission rate signal, i.e., burst-like IP packet signal(s). Similarly, for 16QAM, QPSK and BPSK, transmission capacities of 60 Mbps, 30 Mbps and 15 Mbps are defined respectively. In case the transmission rate of the constant transmission rate signal, e.g., G.703 signal, is set at 6.3 Mbps, 10.5%, 21.0% and 42.0% of the transmission capacity are allocated to respective ones, with the remainders being allocated to variable transmission rate signals, respectively. Note here that these numerical values may be modified on a case-by-case basis in accordance with system configurations and in-use circumstances.

FIG. 4A shows pictorially the case of data being transmitted by 64QAM modulation scheme shown in Table 2 with its transmission capacity of 100 Mbps as an example. In FIG. 4A, numeral 401 designates a variable transmission rate signal that is read within the read time period t1 of (C) in FIG. 2, while 402 indicates a constant transmission rate signal as read within the read period t2 of (F) in FIG. 2. Numeral 403 denotes an exemplary single frame structure of the data that was converted by the modulator unit 132 of modem unit 104 into a predetermined transmission format. To make a long story short, in this invention, the data from the variable transmission rate signal-use Tx-FIFO buffer memory 123-1 and the data from the constant transmission rate signal-use Tx-FIFO buffer memory 123-2 are alternately read out and then sent forth in a form of hybrid data. For example, assume that the one frame structure 403 is of 1 millisecond (msec) with a string of data of 1,000 Kbits being arranged therein for transmission. To perform 6.3 Mbps transmission of G.703 signal that is a constant transmission rate signal, the data as read out of the constant rate signal-use Tx-FIFO buffer memory 123-2 is allocated to 63K bits (corresponding to 6.3%) of 1000 Kbits while allocating the data read from the variable transmission rate signal-use Tx-FIFO buffer memory 123-1 to the remaining 937 Kbits (equivalent to 93.7%) of 1000 Kbits. To do this, the selector 125 is controlled by the control unit 131 to supply resultant hybrid data 403 to the modulator unit 132 while switching between the data from Tx-FIFO buffer memory 123-1 and the data from Tx-FIFO memory 123-2 at a high speed. The modulator 132 operates to apply 64QAM modulation to the hybrid data 403 and then supply the modulated data to the IF transmitter unit 105.

In the state that both the constant transmission rate signal and the variable transmission rate signal are being transmitted by the 64QAM modulation scheme in the way stated supra, whenever the received signal changes in electric field intensity due to rainfall or the like, this change is detected by the control unit 131 of modem unit 104. In case the control unit 131 changes the modulation scheme of the modulator unit 132 to BPSK based on the minimum received signal electric field intensity shown in Table 1, the transmission capacity of data capable of being transmitted by this data transmission apparatus is set at 15 Mbps based on Table 2. In this case, in order to transmit at 6.3 Mbps the constant transmission rate signal, e.g., G.703 signal, 42.0% of the transmission capacity becomes necessary. It is also required that the variable transmission rate signal be sent by the remaining 58.0% of the transmission capacity. To this end, the control unit 131 changes the switching operation of selector 125 in a way as shown in FIG. 4B.

In FIG. 4B, suppose that a single frame structure 404 is of 1 msec with data of 150 kilobits being arranged therein for transmission. To perform 6.3 Mbps transmission of G.703 signal that is a constant transmission rate signal, the control unit 131 controls the selector 125 in such a way as to allocate data from the constant transmission rate signal-use Tx-FIFO buffer memory 123-2 to 63 Kbits (corresponding to 42.0% of the transmission capacity) of 150 Kbits while at the same time allocating data from the variable transmission rate signal-use Tx-FIFO buffer memory 123-1 to the remaining 87 Kbits (equivalent to 58.0% of the transmission capacity) of 150 Kbits. Thus, the selector 125 operates under control of the control unit 131 to supply resultant hybrid data 403 to the modulator unit 132 while switching between the data from Tx-FIFO buffer memory 123-1 and the data from Tx-FIFO buffer memory 123-2 at a high speed. This modulator 132 applies 64QAM modulation (or otherwise BPSK modulation) to the hybrid data 403 (or 404) and then supplies modulated data to the IF transmitter unit 105. An operation that follows is as stated previously.

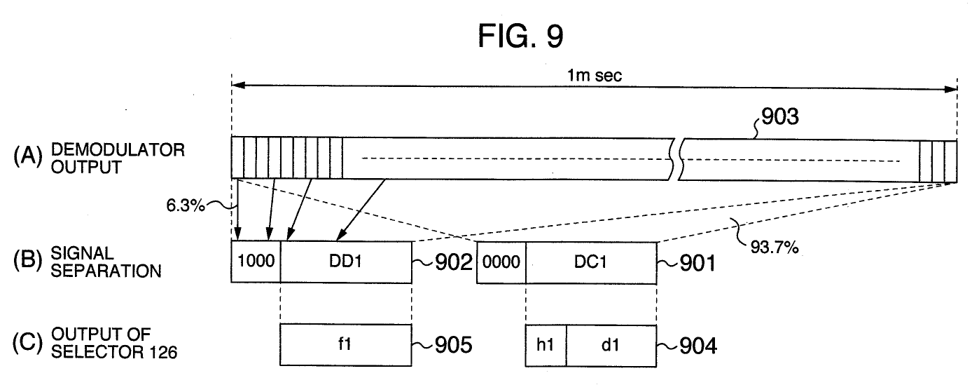

Next, an explanation will be given of the case of signal reception. As already discussed in conjunction with FIG. 7, the hybrid data is being sent to the A radio device 701 via the transmission channels 707 and 708 from the B radio device 702 also. Hence, the hybrid data from the antenna 110 is supplied to the demodulator unit 133 by way of the duplexer 109, RF signal receiver unit 108 and IF receiver unit 107. At the demodulator 133, the signal as sent by 64QAM modulation scheme for example is appropriately demodulated at the control unit 134. An output of this demodulator is indicated by a frame structure 903 shown in (A) of FIG. 9. This frame structure 903 may be similar to the frame structure 403 shown in FIG. 4A, although the data per se is entirely different therefrom. This single frame structure 903 is selectively switched by the selector 126 respectively and then separated or “disassembled” into a variable transmission rate signal 901 and a constant transmission rate signal 902. These signals are shown in (C) and (D) of FIG. 3.

Part (C) of FIG. 3 shows that the data to be written into the Rx-FIFO buffer memory 124-1 having its four-bit header information with the first bit being set at “0”. Under control of the control unit 134 the selector 126 reads this data and then writes it into the Rx-FIFO memory 124-1. An output of the selector 126 at this time is shown at (C) in FIG. 9. More specifically, when writing the data into the Rx-FIFO memory 124-1, the bit array “0000” of the header information is removed, with the original IP packet header information hi and data dl being written as shown by data 904. Additionally, (D) of FIG. 3 shows data to be written into the Rx-FIFO buffer memory 124-2, with the top bit of four bits of its header information being set to “1”. Under control of the controller 134 the selector 126 reads this data and then writes it into the Rx-FIFO memory 124-2. An output of the selector 126 at this time is shown in (C) of FIG. 9. More precisely, when writing the data into the Rx-FIFO memory 124-2, the bit stream “1000” of the header information is removed, resulting in the original data f1 being written as shown by data 905. Note that the write rate is equal to a demodulation speed of the demodulator unit 133—in this case, data write is performed at a speed corresponding to the transmission rate of 64QAM, by way of example.

The data written into the variable transmission rate signal-use Rx-FIFO buffer memory 124-1 is read at a speed corresponding to the transmission rate of the transmission channel that is connected to the input/output terminal 101 and is then output to the input/output terminal 101 through the IO I/F 121. Regarding the data written into the constant transmission rate signal-use Rx-FIFO buffer memory 124 2, this is read at a speed corresponding to the transmission rate of the transmission channel as coupled to the input/output terminal 102 and is then output to this input/output terminal 102 via the IO I/F 122.

As apparent from the foregoing description, in the illustrative embodiment of this invention, it becomes possible to transmit transmission rate-different data over a radiocommunications channel(s). Even in the case of the modulation scheme being changed, it becomes possible to switch it to another appropriate transmission rate in an automated way. Another advantageous feature lies in that the constant transmission rate signal (serial data transmission) is well guaranteeable in the remaining of its transmission band, thereby enabling achievement of the data transmission apparatus with increased reliability and a data transmission system using the same.

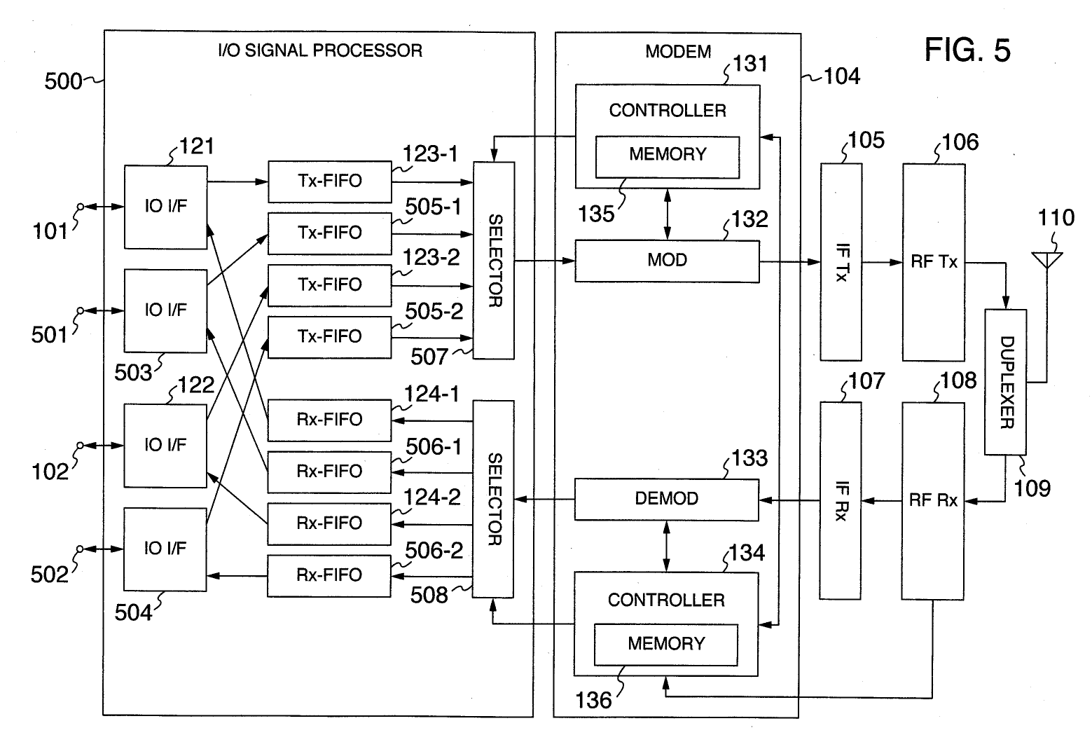

FIG. 5 depicts, in block diagram form, a configuration of a data transmission apparatus in accordance with another embodiment of this invention. Reference numeral 500 designates an input/output signal processor unit. Numeral 501 denotes an input/output terminal. Supplied to this input/output terminal 501 is a variable transmission rate data signal which is different from that of the input/output terminal 101—for example, a burst-like IP packet signal. 502 is an input/output terminal, to which is supplied a constant transmission rate data signal that is different from the signal of the input/output terminal 102, an example of which is a G.703 signal. 503 and 504 indicate input/output interfaces (IO I/Fs); 505-1 is a variable transmission rate signal-use transmit (Tx) FIFO buffer memory; and, 505-2 is a constant transmission rate signal-use Tx-FIFO buffer memory. In addition, 506-1 is a variable transmission rate signal-use receive (Rx) FIFO buffer memory whereas 506-2 is a constant transmission rate signal-use Rx-FIFO buffer memory. Selectors 507 and 508 are controlled by control units 131 and 134, respectively. Note that the same reference numerals are used to designate the same parts or components shown in FIG. 1.

An operation of this apparatus is as follows. Different transmission rate-variable signals, e.g., burst IP packet data signals, are supplied to the input/output terminals 101 and 501. These signals are then sequentially written via IO I/Fs 121 and 503 into the variable transmission rate signal-use Tx-FIFO buffer memory 123-1 and variable transmission rate signal-use Tx-FIFO buffer memory 505-1, respectively. The signals written into the buffer memories are sequentially read out by the selector 507 at a prespecified read rate. In addition, the different transmission rate-constant signals that are supplied to the input/output terminal 102 and 502 are sequentially written via the IO I/Fs 122 and 504 into the constant transmission rate signal-use Tx-FIFO buffer memory 123-2 and constant transmission rate signal-use Tx-FIFO buffer memory 505-2 at a specified write rate. The signals written into these buffer memories are sequentially read by the selector 507 at a specified read rate. Operations of the variable transmission rate signal-use Tx-FIFO buffer memory 123-1, variable transmission rate signal-use Tx-FIFO buffer memory 505-1, constant transmission rate signal-use Tx-FIFO buffer memory 123-2 and constant transmission rate signal-use Tx-FIFO buffer memory 505-2 are each similar to the contents as has been described with reference to FIG. 2. A different point is that while the input data are two kinds of data in FIG. 2, four kinds of data are input in FIG. 5. These four kinds of data are sequentially selected and adequately switched by the selector to thereby supply each data to the modulator unit while adding thereto header information.

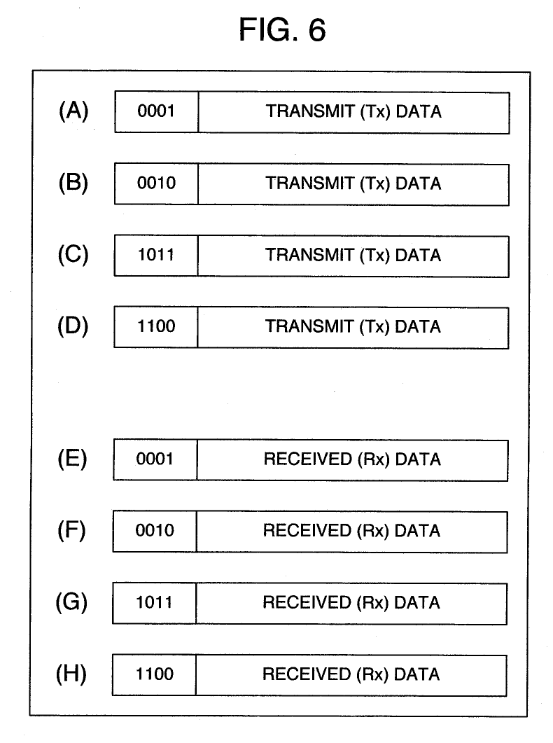

FIG. 6 shows these four kinds of data, which are sequentially selected and adequately switched by the selector 507, with header information respectively. Part (A) of FIG. 6 shows the data that is read from the variable transmission rate signal-use Tx-FIFO buffer memory 123-1, with 4-bit header information “0001” being added thereto to indicate that it is the data from the variable transmission rate signal-use Tx-FIFO buffer memory 123-1. Here, its top bit “0” is the information indicative of a variable transmission rate signal whereas the remaining three bits “001” indicate that it is the data from the variable transmission rate signal-use Tx-FIFO buffer memory 123-1.

Similarly, part (B) of FIG. 6 shows the data that is read out of the variable transmission rate signal-use Tx-FIFO buffer memory 505-1, with 4-bit header information “0010” being added thereto to indicate that it is the data from the variable transmission rate signal-use Tx-FIFO buffer memory 505-1. Here, its top bit “0” is the information indicating that it is a variable transmission rate signal whereas the remaining three bits “010” indicate that it is the data from the variable transmission rate signal-use Tx-FIFO buffer memory 505-1.

Similarly, (C) of FIG. 6 shows the data that is read out of the constant transmission rate signal-use Tx-FIFO buffer memory 123-2, with 4-bit header information “1011” being added thereto to indicate that it is the data from the constant transmission rate signal-use Tx-FIFO buffer memory 123-2. Here, its top bit “1” is the information indicative of a constant transmission rate signal whereas the remaining three bits “011” indicate that it is the data from the constant transmission rate signal-use Tx-FIFO buffer memory 123-2.

Similarly, (D) of FIG. 6 shows the data as read from the constant transmission rate signal-use Tx-FIFO buffer memory 505-2, with 4-bit header information “1100” being added thereto to indicate that it is the data from the constant transmission rate signal-use Tx-FIFO buffer memory 505-2. Here, its top bit “1” is the information indicative of a constant transmission rate signal whereas the remaining three bits “100” indicate that it is the data from the constant transmission rate signal-use Tx-FIFO buffer memory 505-2.

Now then, the header information-added data as read out of respective Tx-FIFO buffer memories 123-1, 505-1, 123-2 and 505-2 are selectively switched, one at a time, by the selector 507 and converted into a combined or “hybrid” data in a way similar to the operation shown in FIG. 4 and then supplied to the modulator unit 132. This operation will be described using Table 3 below.

TABLE 3

| | Transmission | Fixed-Rate | |
|---|---|---|---|
| Modulation | Capacity | Signal | Variable- |
| Scheme | (Mbps) | (6.3 Mbps × 2) | Rate Signal |
| 64QAM | 100 | 12.6% | 87.4% |
| 16QAM | 60 | 42.0% | 79.0% |
| QPSK | 30 | 21.0% | 58.0% |
| BPSK | 15 | 84.0% | 16.0% |

Table 3 indicates some modulation schemes and transmission capacities thereof. For example, in the 64QAM modulation scheme, the transmission capacity is defined to be 100 Mbps. In the case of the transmission rate of a constant transmission rate signal, e.g., G.703 data, being set to 6.3 Mbps, when signals with the transmission rate of 6.3 Mbps are supplied to the input/output terminal 102 and input/output terminal 502 respectively, the transmission capacity of 100 Mbps is allocated in a way which follows: 12.6% of it is assigned to the transmission of data 6.3×2 (=12.6) Mbps of G.703 signal; the remaining 87.4% of the 100 Mbps transmission capacity is assigned to variable transmission rate signals, i.e., the burst-like IP packet signals to be supplied to the input/output terminals 101 and 501.

Similarly, as for 16QAM, QPSK and BPSK, the transmission capacities of 60 Mbps, 30 Mbps and 15 Mbps are set up thereto, respectively. Suppose that the transmission rate of constant transmission rate signal, e.g., G.703 signal, is 6.3 Mbps. In this case, 21.0%, 42.0% and 84.0% of respective transmission capacities are allocated to the constant transmission rate signals being supplied to the input/output terminal 102 and input/output terminal 502, with the remainders being assigned to variable transmission rate signals to be supplied to the input/output terminals 101 and 501. In this way, the transmission band is guaranteed against the constant transmission rate signals being supplied to the input/output terminals 102 and 502 while at the same time allocating the remaining band to the variable transmission rate signals whereby it becomes possible to transmit over-the-air a hybrid signal of the constant transmission rate signals and the variable transmission rate signals over a radiocommunications channel(s). Note that although in this embodiment the description was given under an assumption that the data signals to be supplied to the input/output terminals 102 and 502 are G.703 data signals being fed at the same rate to the input/output terminals 102 and 502, a general arrangement is that constant transmission rate data signals are supplied to the input/output terminals 102 and 502 at different rates. Additionally, the numerical values shown in Table 3 may also be modifiable on a case-by-case basis in accordance with system configurations and in-use circumstances.

The hybrid data as modulated by a specific modulation scheme at the modulator unit 132 is converted by the IF transmitter unit 105 into a signal with its intermediate frequency of 130 MHz for example and then sent forth toward the RF transmitter unit 106. This RF transmitter 106 amplifies the supplied signal for conversion to a radio carrier with a frequency of 18 GHz as an example and then transmits it over-the-air from the antenna 110 to the B radio device 702 via the duplexer 109.

Regarding an inbound signal from the B radio device 702, this signal is supplied via the antenna 110 and duplexer 109 to the RF signal receiver unit 108. The RF receiver 108 amplifies the received signal from the antenna 110 for conversion to a mid frequency of 290 MHz as an example and then supplies it to the IF receiver unit 107. The IF receiver 107 converts the fed signal into a baseband signal, which is supplied to the modem unit 104. At the demodulator unit 133 of this modem 104, the supplied signal is appropriately demodulated and fed to the selector 508. This selector 508 separates respective desired data from the hybrid data and then writes separated data into respective Rx-FIFO buffer memories 124-1, 506-1, 124-2 and 506-2. This operation will be explained using FIG. 6 below.

Part (E) of FIG. 6 indicates the received data as separated from the hybrid data at the selector 508. More specifically, the top one bit “0” in the four bits of its header information indicates the presence of a variable transmission rate signal whereas the remaining three bits “001” indicate that it is the data to be written into the variable transmission rate signal-use Rx-FIFO buffer memory 124-1. This data is written at a predetermined rate into the variable transmission rate signal-use Rx-FIFO buffer memory 124-1. Note that the write rate at this time is controlled by the control unit 134 in a way pursuant to the speed of the data to be demodulated. The written data is read therefrom at a prespecified rate and then sent out of the input/output terminal 101 via the IO I/F 121 toward its associated transmission channel. Additionally the read rate is the speed that corresponds to the transmission rate of the transmission channel that is connected to the input/output terminal 101.

Similarly, part (F) of FIG. 6 indicates another received data as separated from the hybrid data at the selector 508. More specifically, the top one bit “0” in the four bits of the header information indicates the presence of a variable transmission rate signal whereas the remaining three bits “010” indicate that it is the data to be written into the variable transmission rate signal-use Rx-FIFO buffer memory 506-1. This data is written at a predetermined rate into the variable transmission rate signal-use Rx-FIFO buffer memory 506-1. The written data is read at a prespecified rate and sent out of the input/output terminal 501 via the IO I/F 503 to a transmission channel associated therewith.

In addition, part (G) of FIG. 6 indicates still another received data as separated from the hybrid data at the selector 508. Specifically, the top one bit “1” in the four bits of header information indicates the presence of a constant transmission rate signal whereas the remaining three bits “011” indicate that it is the data to be written into the constant transmission rate signal-use Rx-FIFO buffer memory 124-2. This data is written at a predetermined speed into the constant transmission rate signal-use Rx-FIFO buffer memory 124-2. The written data is read at a prespecified speed and transmitted from the input/output terminal 102 via the IO I/F 122 to its associated transmission channel.

Similarly, (H) of FIG. 6 indicates yet another received data as separated from the hybrid data at the selector 508. More specifically, the top one bit “1” in the four bits of header information indicates the presence of a constant transmission rate signal while the remaining three bits “100” indicate that it is the data to be written into the constant transmission rate signal-use Rx-FIFO buffer memory 506-2. This data is written at a predetermined rate into the constant transmission rate signal-use Rx-FIFO buffer memory 506-2. The data thus written is read at a prespecified rate and sent out of the input/output terminal 502 via the IO I/F 504 to its associative transmission channel.

As has been described in detail, the intended data transmission apparatus and system are achievable and capable of combining together those inbound data from a plurality of transmission channels and transmitting over-the-air the combined data via a radiocommunications link(s) while offering automated switchability of the modulation scheme also in accordance with the transmission characteristics of such transmission links or channels. Also importantly, unwanted data dropout no longer occurs even in the case of the hybrid data being transmitted from the plurality of transmission channels. This can be said because the apparatus and system employ the data band-guaranteed transmission methodology for transmission of constant transmission rate data, as in serial data transmission. It is noted that although the description was given of the case of two input/output terminals in the embodiment of FIG. 1 or the case of four input/output terminals in the embodiment of FIG. 5, these are not restrictive of this invention and may be readily modified by those skilled in the art to use a different number of input/output terminals—e.g., three I/O terminals, five or more I/O terminals-without deteriorating the effects and advantages of this invention. Further, various combinations are available including, but not limited to, one input/output constant transmission rate data, two I/O variable-rate data, two I/O constant-rate data or one output variable-rate data. These data combinations are readily realizable by a skilled person by changing the number of Tx/Rx buffer memories and also by appropriately modifying the operations of the selectors 125 and 126 (or 507 and 508) under control of the controllers 131 and 134.

While the principles of this invention have been described above in detail, the invention should not exclusively be limited to the illustrative embodiments of the data transmission apparatus and data transmission system and may be widely applicable to those other than the data transmission apparatus and system as disclosed herein.

It should be further understood by those skilled in the art that although the foregoing description has been made on specific embodiments of the invention, this invention is not limited thereto and various modifications and alterations may be made without departing from the spirit of the invention and the scope of the appended claims.

1. A data transmission apparatus comprising:
at least one first input/output terminal which inputs of a data signal of variable transmission rate;
at least one second input/output terminal which inputs of a data signal of constant transmission rate;
an input/output signal processing unit which inputs of the data signals from the first input/output terminal and the second input/output terminal;
a modulator unit operative to modulate an output of the input/output signal processing unit;
a first control unit for controlling the modulator unit; and
a transmitter unit for sending an output of the modulator unit via a radiocommunication channel, wherein
said input/output signal processing unit includes a first transmission buffer memory for writing thereinto the data signal from the first input/output terminal, a second transmission buffer memory for writing therein the data signal from the second input/output terminal, and a first selector for reading out of the first transmission buffer memory and the second transmission buffer memory while switching therebetween at a prespecified read speed, and wherein the switching of the first selector is controlled by said first control unit.

2. The data transmission apparatus according to claim 1, wherein the first selector operates under control of the control unit to perform a switching operation to allocate to the data signal as read from the second transmission buffer memory a transmission capacity corresponding to the data signal of constant transmission rate and being included in a transmission capacity of the data signal to be modulated at the modulator unit while allocating a remaining transmission capacity of the data signal to be modulated at the modulator unit to transmission of the data signal as read out of the first transmission buffer memory.

3. The data transmission apparatus according to claim 1, wherein information indicative of data as read from the first transmission buffer memory and the second transmission buffer memory is added to the data signals as read from the first transmission buffer memory and the second transmission buffer memory respectively.

4. The data transmission apparatus according to claim 1, further comprising:
a receiver unit for receipt of a data signal to be sent over a radiocommunication channel;
a demodulator unit for demodulation of an output of the receiver unit; and
a second control unit for control of the demodulator unit, and wherein
the input/output signal processing unit is supplied to an output of the demodulator unit, wherein
said input/output signal processing unit further includes a second selector, a first reception buffer memory for writing thereinto an output of the second selector and a second reception buffer memory, and wherein
said second selector is operable based on control of the second control unit to switch the output of said demodulator unit for writing into the first reception buffer memory and the second reception buffer memory respectively and to output data signals being written into the first reception buffer memory and the second reception buffer memory to the first input/output terminal and the second input/output terminal respectively.

5. A data transmission method for use in a data transmission apparatus having at least one first input/output terminal, at least one second input/output terminal, an input/output signal processing unit for input of data signals from the first input/output terminal and the second input/output terminal, a modulator unit operative to modulate an output of the input/output signal processing unit, and a transmitter unit for sending an output of the modulator unit via a radiocommunication channel, the input/output signal processing unit including a first transmission buffer memory, a second transmission buffer memory, and a first selector, said data transmission method comprising the steps of:
receiving a data signal of variable transmission rate from the first input/output terminal;
receiving a data signal of constant transmission rate from the second input/output terminal;
writing the data signal of variable transmission rate into the first transmission buffer memory;
writing the data signal of constant transmission rate into the second transmission buffer memory;
reading data signals out of the first transmission buffer memory and the second transmission buffer memory while causing the first selector to switch therebetween at a prespecified speed; and
modulating the read data signal for transmission via the radiocommunication channel.

6. The data transmission method according to claim 5, further comprising the steps of:
causing the first selector to operate under control of the control unit to allocate to the data signal as read from the second transmission buffer memory a transmission capacity corresponding to the data signal of constant transmission rate and being included in a transmission capacity of the data signal to be modulated at the modulator unit; and
causing the first selector under the control of said control unit to allocate a remaining transmission capacity of the data signal to be modulated at the modulator unit to transmission of the data signal as read out of the first transmission buffer memory.

7. The data transmission method according to claim 5, further comprising the step of:
adding information indicative of data as read from the first transmission buffer memory and the second transmission buffer memory to the data signal being read from the first transmission buffer memory and the second transmission buffer memory, respectively.

8. The data transmission method according to claim 5, wherein said data transmission apparatus further comprises a receiver unit for receiving a data signal to be sent via a radiocommunication channel, a demodulator unit for demodulation of an output of the receiver unit, and the input/output signal processing unit to which an output of the demodulator unit is supplied, wherein said input/output signal processing unit further includes a second selector, a first reception buffer memory for writing thereinto an output of the second selector and a second reception buffer memory, and wherein said transmission method comprises the steps of:
causing the second selector to operate based on control of the second control unit to switch the output of said demodulator unit for writing into the first reception buffer memory and the second reception buffer memory respectively; and
outputting data signals being written into the first reception buffer memory and the second reception buffer memory toward the first input/output terminal and the second input/output terminal, respectively.

9. A data transmission system having a first radio device and a second radio device which communicate each other via a radiocommunication channels, wherein the first radio device comprises at least one first input/output terminal for input of a data signal being variable in transmission rate, at least one second input/output terminal for input of a data signal being kept constant in transmission rate, an input/output signal processor unit for input of data signals from the first input/output terminal and the second input/output terminal, a modulator unit operative to modulate an output of the input/output signal processor unit, a first control unit for control of the modulator unit, and a transmitter unit for sending an output of the modulator unit over the radiocommunication channel, wherein said input/output signal processor unit includes a first transmission buffer memory for writing thereinto the data signal from said first input/output terminal, a second transmission buffer memory for writing therein the data signal from said second input/output terminal, and a first selector for reading data out of the first transmission buffer memory and the second transmission buffer memory while switching therebetween at a prespecified read speed, wherein the switching of the first selector is controlled by said first control unit, and wherein the second radio device receives the data signal from said transmitter unit.

10. The data transmission system according to claim 9, wherein the system is realized by a fixed wireless access scheme.

11. The data transmission apparatus according to claim 1, wherein the modulator unit modulates the output of said input/output signal processing unit by an adaptive modulation technique.

12. The data transmission apparatus according to claim 1, wherein a modulation technique of the output of said input/output signal processing unit is set by an operation of a user.

13. The data transmission apparatus according to claim 1, wherein the control unit switches the first selector in such a way as to output with higher priority the data signal of constant transmission rate being stored in the second transmission buffer memory.

14. The data transmission apparatus according to claim 1, wherein the data signal of variable transmission rate is a signal where data occurs burst.

15. The data transmission apparatus according to claim 3, wherein a single packet is comprised of the information and the data signal and wherein the control unit controls the switching of said first selector to enable readout on a per-packet basis.

16. The data transmission apparatus according to claim 15, wherein based on the transmission rate of the data signal of constant transmission rate, the control unit controls switching of the first selector.

17. The data transmission apparatus according to claim 15, wherein based on a transmission capacity of modulation scheme, said control unit controls the switching of the first selector.
